(19) United States
(12) Patent Application Publication
(10) Pub. No.: US 2002/0152259 A1
(43) Pub. Date: Oct. 17, 2002

(54) Pre-committing instruction sequences

(75) Inventors: Son Dao Trong, Stuttgart (DE); Jens Leenstra, Bondorf (DE); Wolfram Sauer, Nufringen (DE); Birgit Schubert, Schoenaich (DE); Hans-Werner Tast, Weil im Schoenbuch (DE)

Correspondence Address: Floyd A. Gonzalez, IBM Corporation, 2455 South Road, P386, Poughkeepsie, NY, 12601, US

(73) Assignee: International Business Machines Corporation, Armonk, NY

(21) Appl. No.: 10/120,909

(22) Filed: Apr. 11, 2002

(30) Foreign Application Priority Data
Apr. 14, 2001 (EP) 01109247.5

(51) Int. Cl. G06F 15/16

(52) U.S. Cl. 709/201

(57) ABSTRACT

The present invention relates to improvements of out-of-order CPU architectures regarding performance purposes, and in particular to improved methods for serializing and committing instructions. It is proposed to split the prior art commit into at least two cooperating processes: a pre-committer and a ‘main’ committer. According to the invention the main committer is blocked until detecting (335) that a next sequential external instruction is ready for commitment.

This accelerates overall processing speed in particular when an external instruction is cracked into a relatively large number of internal instructions. In this case, internal instructions which are ready for being committed can be earlier processed compared to prior art.

### BACKGROUND OF THE INVENTION

The present invention relates to improvements of out-of-order CPU architectures regarding performance purposes. In particular it relates to an improved method and system for serializing and committing instructions.

The present invention has a quite general scope which is not limited to a vendor-specific processor architecture because its key concepts are independent therefrom.

Despite this fact it will be discussed with a specific prior art processor architecture.

With reference to FIG. 1 a schematically depicted prior art out-of-order processor 100—in this example a IBM S/390 processor—has as two essential components, a so-called Instruction Window Buffer 110, further referred to herein as IDB, and a so-called Storage Window Buffer 185, further referred to herein as SWAB.

The IDB comprises instructions working on registers—see for example the register file 130, whereas the SWAB comprises instructions working on a data cache 190, Level I or a Level II cache 195. IDB and SWAB are autonomous units, although cooperating closely: The IDB issues instructions to compute the storage addresses on which the SWAB instructions operate. The SWAB loads data from these addresses and forwards it to the IDB for further processing. The SWAB also stores data provided by the IDB to these addresses. Loads and stores operate on the data cache. The SWAB is referred to in some literature as Load/Store Unit, as well.

In order to provide a good understanding of the concepts a short overview is given on the out-of-order processor depicted in FIG. 1.

After coming from an instruction cache 160 and passed through a decode and branch prediction unit 170 the instructions are dispatched still in-order. In this out-of-order processor the instructions are allowed to be executed and the results written back into the IDB as well as the SWAB out-of-order.

In other words, after the instructions have been fetched by a fetch unit 170, stored in the instruction queue 140 and have been renamed in a renaming unit 115, they are stored in-order into a part of the IDB called reservation station 120. From the reservation station the instructions may be issued out-of-order to a plurality of instruction execution units 180, and the speculative results are stored in a temporary register buffer, called reorder buffer 125, abbreviated herein as ROB. These speculative results are committed (or retired) in the actual program order thereby transforming the speculative result into the architectural state within a register file 130, a so-called Architected Register Array (ARA). In this way it is assured that the out-of-order processor with respect to its architectural state behaves like an in-order processor. Very similar mechanisms are used in the SWAB to implement out of order loads and stores, while assuring in order commitment of instructions. The architectural state is contained in the Data Cache 190 in this case.

After said general introduction the area of the instruction-commit problem underlying the present invention will be focussed on next below.

The method of using a reorder buffer for committing (retiring) instructions in sequence in an out of order processor has been fundamental to out of order processor design. In the case of a complex instruction set computer (CISC) architecture complex instructions are cracked (mapped) into sequences of primitive instructions. Nullification in case of an exception is a problem for these instructions, because the exception may occur late in the sequence of primitive instructions. It can in fact be detected by the very last primitive. An example of a CISC architecture is the IBM S/390 processor architecture.

In order to increase the overall processor performance in regard of the large split-up between one external instruction and the large plurality of associated internal instructions due to the instruction cracking process and in regard of steadily increasing clock rates the so-called test access instructions are used in current designs (see U.S. Pat. No. 5,790,844) either in microcode or in hardware to check for exceptions in advance. The intention is to know at the earliest possible point in time if an instruction processed in the IDB is blocked because of a data access exception, regarding the corresponding data access performed in the SWAB. It should be noted that said exceptions—for example when the SWAB cannot supply the data requested by the IDB—play a key role for overall processor performance in the prior art cooperation between IDB and SWAB, as it was already mentioned above.

The above mentioned test access instructions, however, are not yet satisfying because they must be implemented separately for each complex instruction which requires it. Thus, an alternative is desirable.

### SUMMARY OF THE INVENTION

It is thus an objective of the present invention to provide for efficient serialization.

This object is achieved by the features stated in the enclosed independent claims. Further advantageous arrangements and embodiments of the invention are set forth in the respective claims.

The method and system of the present invention allows the committing of cracked instructions without introducing test access instructions,

allows the synchronization of instruction commitment in distributed reorder buffers,

and enables an optimized solution for the pending store problem

in a superscalar processor, containing a plurality of execution units, which allows out of sequence instruction execution and completion, in order instruction fetch, decode and commitment, and a cracking mechanism for translating instructions of an external architecture to one or a sequence of multiple instructions of an architecture internal to the processor. Said processor incorporates a table of instructions, which have been decoded and dispatched, but not yet committed, usually called reorder buffer (ROB) or completion table. The pre-committer, which is subject of this invention, scans the ROB for committable instructions running ahead of the actual committer. It blocks the committer until it detects that the next sequential external instruction is ready for commitment. The pre-committer can block the committer in the same ROB or a different part of a distributed ROB, thereby allowing a distributed ROB implementation.

The method according to its first aspect comprises the steps of:

a. operating a split-up commit process comprising at least one first subcommit process operating as a precommitter upstream of a second main committer, whereby said at least one first pre-committer evaluates control information concerning the instruction processing progress,

b. blocking said second main committer until detecting that a next sequential external instruction is ready for commitment.

The general advantage is to improve the processor performance in particular when an external instruction is cracked into a relatively large number of internal instructions. In this case, internal instructions which are ready for being committed can be processed earlier compared to prior art. Thus, performance is increased.

When—further—the control information reflects the occurrence of exceptions, in particular of data access exceptions as e.g., protection exceptions or page miss, then as an advantage those exceptions can be detected earlier and can thus be handled faster.

Further, the concept can be applied to a processor containing multiple (distributed) ROBs as well, thus illustrating its general usability:

The method according to its first aspect is extendible such that the instruction stream is processed in at least two Reorder Buffers, and at least one subcommit process generates information which is usable for synchronizing the operation of said at least two Reorder Buffers. Thus, a control signal can be generated by either one or both of said commit processes in order to tell the respective other committer any information which might be used for accelerating the commit work.

In particular, when different types of instructions are processed in respective different ROBs this feature provides for overall performance increase.

Separating ROBs for different classes of instructions (e. g. register instructions and load/store instructions or integer and floating point instructions) allows the commitment of one type of instructions, while there may be an instruction blocking commitment of instructions of the other type. Earlier commitment of instructions allows resources (ROB entries) to be freed earlier and thereby allows earlier use by following instructions. This improves the flow of instructions through the ROBs and thus the performance of the processor.

Distributed ROBs, which are facilitated by this invention, also allow a smaller and therefore more effective implementation than a single large ROB. Since operations on the ROB are often critical for the cycle time, a more efficient handling can improve the cycle time of the processor.

Furthermore, when different types of data are processed by the instructions as, for example, integer/floating point data or scalar/multimedia pairs then said data can be processed separately because the respective data has specific respective instruction processing requirements. This increases performance as well.

Further, when a first ROB processes instructions accessing registers, and a second ROB processes instructions accessing a data cache, or other data storage system this feature can be advantageously exploited for committing cracked instructions without introducing so-called ‘test access’ instructions as e.g., required for the prior art method cited above (U.S. Pat. No. 5,790,844) because the pre-committer takes over this role inherently during its operation. Thus, this avoids to provide for an entire type of instruction which increases performance as well and simplifies the overall system.

Furthermore, when stalling said precommitter at a load instruction which gets data forwarded from a store instruction until said data is visible to all processors in a multiprocessor system then this feature advantageously solves the problem known in the art as ‘pending store problem’.

Thus, in short words, the pre-committer mechanism of the current invention avoids the need of test access instruction in total, thereby improving performance.

Furthermore, it provides a very general mechanism, which solves the problem of detecting exceptions before starting to commit an instruction for all instructions in a uniform way.

A further aspect is that the present invention covers the serialization which has been implemented in various different ways (e.g. U.S. Pat. Nos. 5,257,354; 5,764,942). A serialization problem solved with this invention occurs, if strict ordering of storage accesses is required by the architecture. The pre-committer mechanism of the present invention provides a means of exactly determining the point, at which serialization needs to occur, thereby improving the performance compared to coarser serialization methods.

Further, with respect to the strong need of effectively synchronizing distributed ROBs the pre-committer concept allows a committer to proceed to the maximum possible place in the ROB, leaving the other committer temporarily behind. The utilization of that ROB and thereby the overall performance can be significantly improved by that mechanism.

### BRIEF DESCRIPTION OF THE DRAWINGS

These and other objects will be apparent to one skilled in the art from the following detailed description of the invention taken in conjunction with the accompanying drawings in which:

FIG. 1 is a schematic diagram showing the basic components of a prior art out-of-order processor,

FIG. 2 is a schematic diagram showing a reorder Buffer (ROB) with cracked instruction, a committer and a precommitter, according to an embodiment,

FIG. 3 is a schematic diagram showing essential steps of the control flow of the pre-committer algorithm,

FIG. 4 is a schematic diagram showing essential steps of the control flow of the respective main committer algorithm,

FIG. 5 is a schematic diagram showing the cooperation between two ROBs ROB-A, and ROB-B in which arrangement ROB-B is shown to have a pre-committer according to FIG. 2,

FIG. 6 is a rough table sketch illustrating the so-called ‘pending store’ problem, and

FIG. 7 is a schematic sketch illustrating an solution of said ‘pending store’ problem by aid of the pre-committer concept.

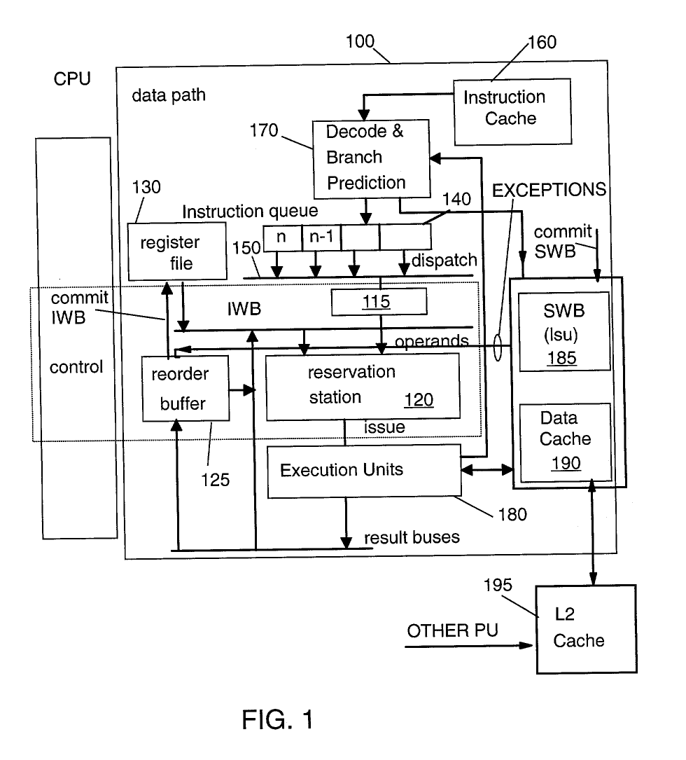

### DESCRIPTION OF THE PREFERRED EMBODIMENT

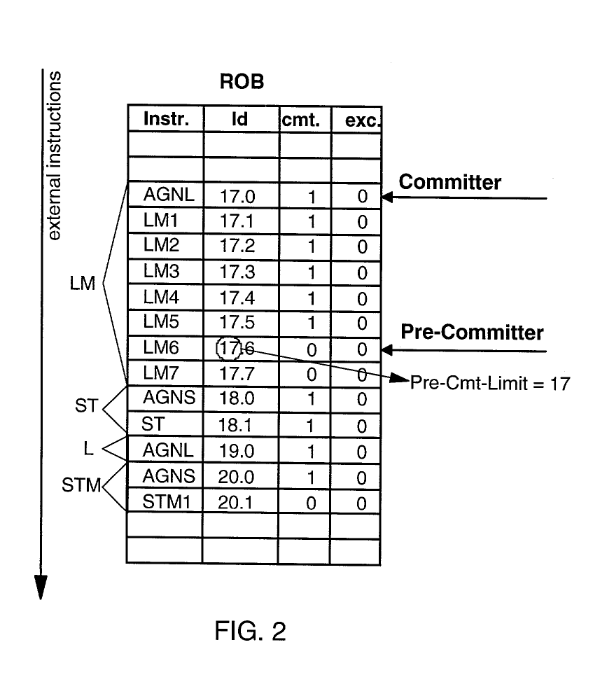

With general reference to the figures and with special reference now to FIG. 2 showing a snapshot of the ROB, each row of the ROB represents one internal instruction with an opcode contained in the first, most left table column (Instr.), an identifier (Id) in the second, a commit flag (cmt.); in the third, and an exception flag (exc.), in the fourth column.

Typically there will be other data in the ROB, too, which is not relevant for the present invention. An example is the instruction “LM2”, which is part of a sequence of internal instructions (AGNL-LM7), to implement one external instruction (LM on the left side).

“LM2” has the Id “17.2”. It should be noted that the Id consists of two parts, one identifying the external instruction (17=LM) and one identifying the internal instruction within the sequence (2=LM2). The instruction is committable (cmt=1) and has no exceptions (exc=0). On the left hand side the sequence of external instructions is shown (LM . . . ST . . . L . . . STM) including their mapping to the internal sequence.

Two pointers are depicted on the right hand side. The committer pointer always points to the oldest instruction in the ROB. The Pre-committer (pointer) points to the oldest instruction, that is not yet committable, either because the cmt flag is still 0 or an exception occurred. The external Id part of the instruction pointed to by the pre-committer is the so-called pre-committer limit.

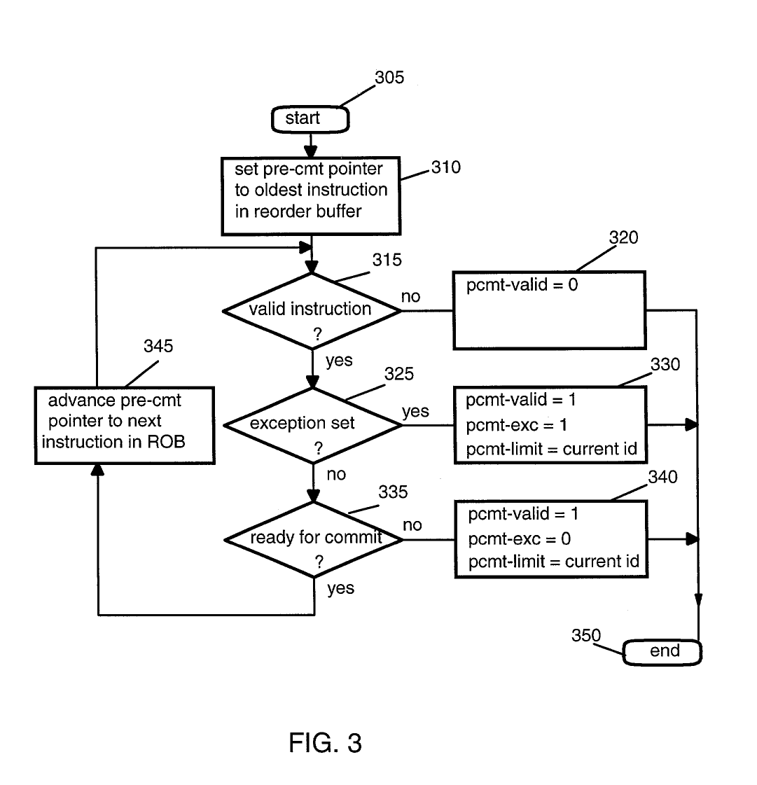

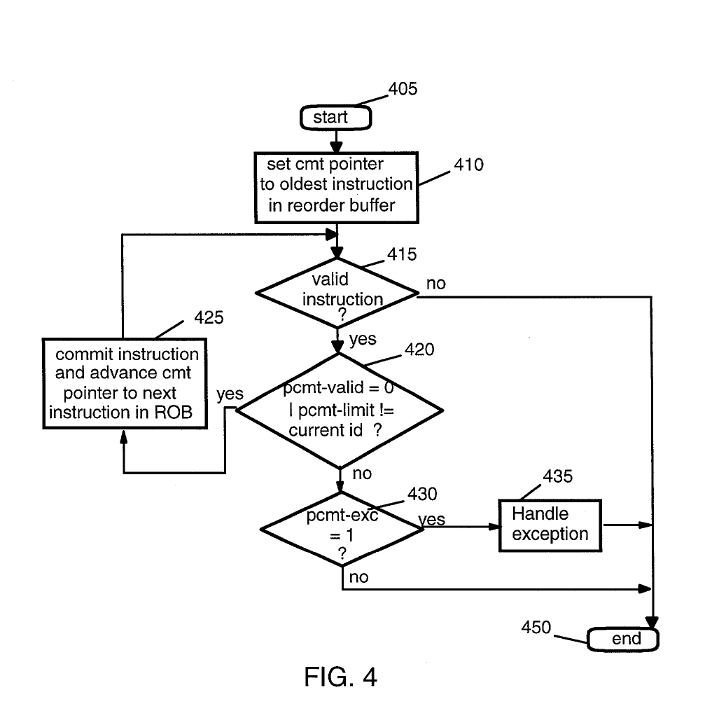

Next, and with reference to FIGS. 3 and 4 which define the algorithms to compute the committer and pre-committer pointers in every cycle further details on the embodiment is given.

FIG. 3 shows the algorithm for computing the pre-committer pointer. At the start the pre-committer pointer is set to the oldest entry in the ROB, step 310. First, it is checked—step 320—whether the entry pointed to by the pre-committer is valid.

If not valid, the pre-committer is beyond the last entry in the ROB and there is no limit for the committer defined by the pre-committer. In this case flag pcmt-valid is set to 0, step 320, and the algorithm ends, step 350.

Otherwise the exception bit of the current entry is tested—step 325. If there is an exception, the pre-committer indicates an exception (pcmt-exc=1) together with the current instruction Id (pcmt-limit=current Id) and a valid limit (pcmt-valid=1), step 330. The algorithm terminates at this point, step 350.

If no exception is found, the cmt flag is tested, step 335. If not set, the instruction is not committable and this is indicated to the committer, step 340.

Otherwise the pre-committer pointer is advanced to the next entry in the ROB, step 345—and the loop starts again with checking for a valid entry—step 315.

Depending on the implementation of this algorithm in hardware there may or may not be a limit to the number of entries the pre-committer can look at. A limit of n would mean that at most n entries starting at the current pre-committer pointer can be looked at.

FIG. 4 illustrates the algorithm for committing entries and computing the committer pointer.

After the start in step 405, the pointer is set to the oldest entry in the ROB, step 410. Then, the pointer is checked for a valid entry, step 415.

If the entry is not valid, the algorithm terminates, step 450. Otherwise it is checked, step 420, whether the pre-committer limit is invalid (pcmt-valid==0) or the current instruction Id is unequal to the pre-committer limit (pcnt-limit!=current ID).

If one of these conditions holds, the next instruction can be safely committed and the committer pointer can be advanced, step 425. Otherwise (pre-committer limit is valid and equal to current instruction Id), the pre-committer exception flag is tested, step 430. If set, an exception occurs and exception handling mechanisms must be triggered by the committer, step 435. Otherwise the algorithm terminates without exception handling, step 450.

Depending on the implementation of this algorithm in hardware there may or may not be a limit to the number of entries the committer can look at. A limit of n would mean that at most n entries starting at the current committer pointer can be looked at.

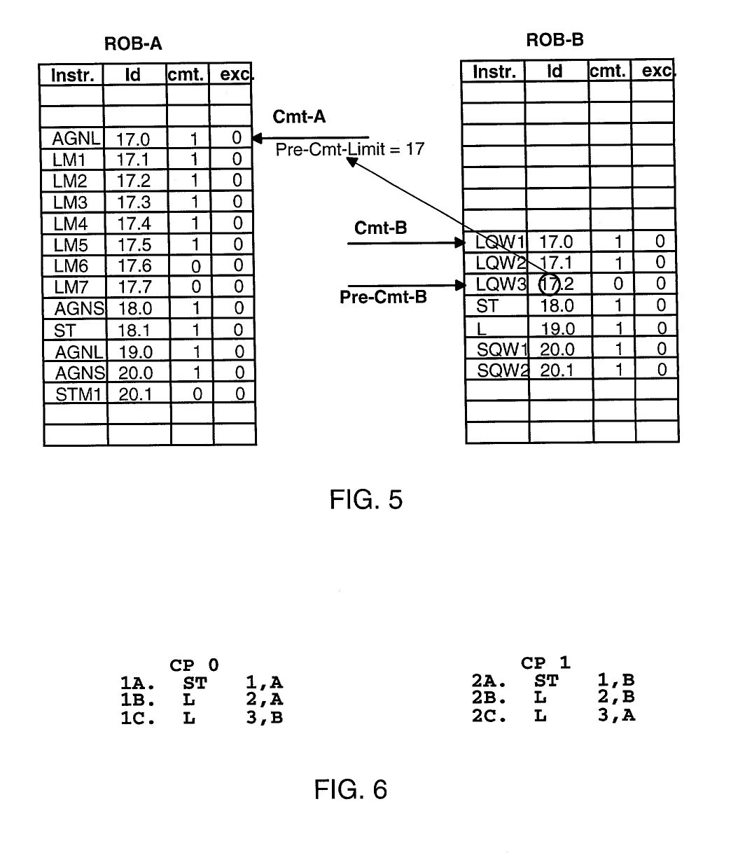

Next, and by aid of the schematic diagram of FIG. 5 showing the cooperation between two ROBs ROB-A, and ROB-B in which arrangement ROB-B is shown to have a pre-committer according to FIG. 2, a kind of distributed ROB implementation is explained in more detail.

The processor contains two ROBs: ROB-A (left side) holds instructions dealing with register operands, ROB-B has basically the same structure and holds instructions dealing with storage operands. It should be added that other criteria for splitting the ROB are also possible the embodiment thus having exemplary character only.

ROB-A has already been explained with reference to FIG. 2. ROB-B in particular, comprises actual load and store quad-word instructions (LQW . . . , SQW . . . ) related to external instructions LM, STM, L, and ST. Instructions appear in the external sequence in both ROBs. Related entries in both ROBs are associated by related Ids. In particular, external Ids are unique and instructions with the same external Id belong to the same external instruction (e.g., AGNL-LM7 and LQW1-LQW3 all belong to the same external LM).

The committer shown in ROB-A must not commit an instruction, until it is safe to do so. It is safe to do so, after all the related instructions in ROB-A and ROB-B have been executed without an exception. Therefore, the ROB-B pre-committer denoted as Pre-Cmt-B in the drawing is used to control the ROB-A committer, Cmt-A.

FIG. 5 shows a pre-committer for ROB-B only. This was done for the sake of simplicity and thus for improving clarity. There could be a pre-committer in ROB-A too, in which case both committers would be controlled by the pre-committers.

FIG. 6 shows an instruction sequence causing the so-called “pending store problem”. This problem occurs only in computer architectures, which demand strong storage ordering like the IBM S/390 architecture does. ‘Strong ordering’ means that all stores must appear to be in sequence as observed by another processor in the system. The same must be true for all load instructions.

A small piece of code on two processors (CP0 and CP1) of a multiprocessor system is shown in FIG. 6. The first instruction (1A) on CP0 stores register 1 to storage address A. The second instruction (1B) loads register 2 from address A.

Because both instructions refer to the same address, the load has to occur after the store: This fact is denoted herein by 1A<1B. The third instruction (1C) loads register 3 from storage address B. Because of the strong ordering property load instructions (loads) have to remain in sequence: 1B<1C. In summary it yields: 1A<1B<1C.

By the same arguments we can deduce: 2A<2B<2C. If 1C loads the old value from storage address B, it follows: 1C<2A, and therefore 1A<1B<1C<2A<2B<2C. Especially 1A<2C means that instruction 2C on CP1 must load the new value (stored by 1A) into register 3. By the same argument it follows, that if 2C loads the old value, 1C must load the new value. Thus we can deduce that it is not allowed according to the architecture that both instructions 1C and 2C load the old values.

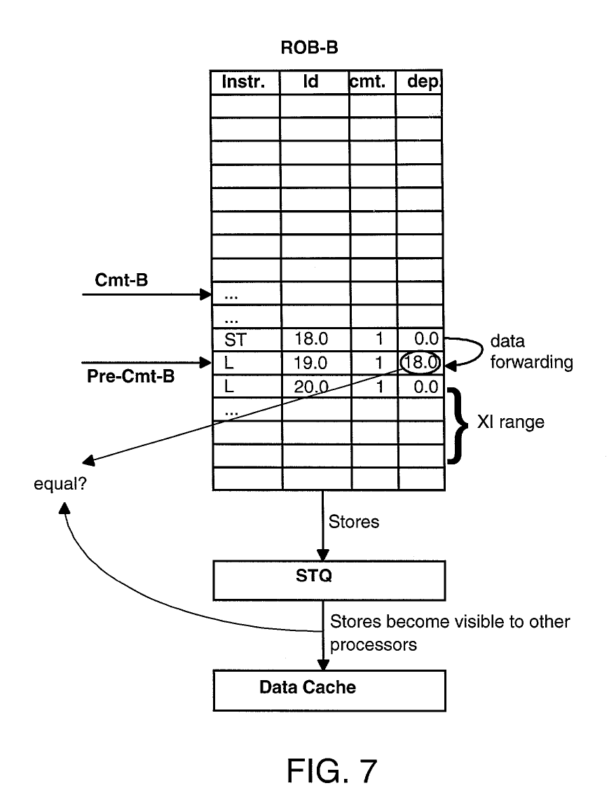

FIG. 7 shows the solution of the ‘pending store’ problem using the pre-committer concept. ROB-B contains the sequence of instructions described above: A store instruction (store) (ST) followed by two loads (L), see the first column in FIG. 7. ROB-B also contains a column “dep.”, which is used to denote data dependencies between load and store instructions.

The first load uses the same storage address as the preceding store does, which is indicated by the Id “18.0” in the dependency column and for clarity also by the “data forwarding” arc. Data will be physically forwarded either directly in the ROB or in the related load and store queues depending on the respective implementation.

The mechanism for communicating stores between processors in a system is the prior art ‘cross invalidate’ (XI, cross interrogate) signal, by which one processor requests all other processors to invalidate their copies of a given cache line specified by the line address. Instructions preceding the current pre-committer pointer can be considered completed and older than the instruction causing the XI signal. Therefore only instructions following the pre-committer are effected by an XI.

If the address of the XI and the address of a load in that range matches, the load and all following instructions will be purged from the processor, and it will be fetched and executed again. The instruction directly pointed to by the pre-committer can be handled in two different ways. Basically, it can be subjected to being purged in the same way as the instructions following it.

A preferred solution does not purge it, but only invalidates its source data, which guarantees forward progress on the processor.

Stores on the other hand, which precede the pre-committer are complete, but not yet visible to other processors in the system. Typically, they are moved to a store queue denoted as STQ in the drawing, after being committed. Finally, they are stored in the data cache, which is the point at which they become visible to all other processors in the system. Before, the processor had been granted exclusive access to the line by the system.

According to the present invention the ‘pending store’ problem can be solved, for example, by stalling the pre-committer at a load instruction, which got data forwarded from a store instruction, until that store instruction is visible to all other processors in the system, i.e., was stored in the cache. The stalling of the committer can of course be implemented in different ways. In any case the ROB needs to keep the information of data forwarded between stores and loads. The information is present at the time of the physical forwarding, typically as the Id of the instruction generating the data put into a dependency field, denoted as ‘dep’, see the right most column in the drawing in the receiving instruction.

One implementation requires the pre-committer to compare the “dep.” field of the current instruction with the most recent store Id being stored into the cache.

Another alternative requires a “stall committer” bit in the ROB, which is switched on, when data is being forwarded and switched off, when the source store is put into the data cache.

This mechanism solves the pending store problem, because with reference back to FIG. 6 assuming 1C receives old data (1C<2A), then the pre-committer in CP1 is stalled on instruction 2B long enough to recognize the XI caused by instruction 1A. As a consequence instruction 2C will be purged from CP1 and re-executed, which means that 2C receives the new data.

Thus, as reveals from the above description a person skilled in the art should be able to appreciate the disclosure in regard of its scope, feasibility, and functionality.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for operating an out-of-order processor in which a commit process includes a pipeline for processing an instruction stream, said commit process working on a reorder buffer in which instructions are reordered after out-of-order execution, the method comprising the steps of:
operating a split-up commit process comprising at least one first subcommit process operating as a precommiter upstream of a second main committer,
said at least one first precommitter evaluating control information concerning the instruction processing progress, and
blocking said second main committer until detecting that a next sequential external instruction is ready for commitment.

2. The method according to claim 1 in which the control information reflects the occurrence of exceptions in particular ones of data access exceptions.

3. The method according to claim 1 in which the instruction stream is processed in at least two reorder buffers, and at least one subcommit process generates information usable for synchronizing the operation of said at least two reorder buffers.

4. The method according to claim 1 in which different types of instructions are processed in respective different reorder buffers.

5. The method according to claim 4 further comprising the steps of:
processing with a first reorder buffer, instructions accessing registers, and
processing with a second reorder buffer, instructions accessing a data cache or other data storage system.

6. The method according claim 1 further comprising the step of:
stalling said precommitter at a load instruction which gets data forwarded from a store instruction until said data is visible to any processors in use.

7. A system for operating an out-of-order processor comprising:
a pipeline for processing an instruction stream in a commit process,
a reorder buffer worked on by said commit process in which instructions are reordered after out-of-order execution,
a split-up commit process having at least one first subcommit process, and
a second main comitter,
said first subcommit process operated on by said split-up commit process, said first subcommit process operating as a precommiter upstream of said second main committer,
said at least one first precommitter evaluating control information concerning the instruction processing progress, and
said second main committer blocked until detecting that a next sequential external instruction is ready for commitment.

8. The system according to claim 7 in which the control information reflects the occurrence of exceptions in particular ones of data access exceptions.

9. The system according to claim 7 further comprising at least two reorder buffers, said instruction stream is processed in said at least two reorder buffers, and said at least one subcommit process generates information usable for synchronizing the operation of said at least two reorder buffers.

10. The system according to claim 7 in which different types of instructions are processed in respective different reorder buffers.

11. The system according to claim 10 in which a first reorder buffer processes instructions accessing registers, and a second reorder buffer processes instructions accessing a data cache or other data storage system.

12. The system according claim 7 further comprising at least one processor, and wherein said precommitter is stalled at a load instruction which gets data forwarded from a store instruction until said data is visible to any processors in use.

13. A program product suable with a system for operating an out-of-order processor in which a commit process includes a pipeline for processing an instruction stream, said commit process working on a reorder buffer in which instructions are reordered after out-of-order execution, said program product comprising:
a computer readable medium having recorded thereon computer readable progam code performaing the method comprising:
operating a split-up commit process having at least one first subcommit process operating as a precommiter upstream of a second main committer,
said at least one first precommitter evaluating control information concerning the instruction processing progress, and
blocking said second main committer until detecting that a next sequential external instruction is ready for commitment.

14. The program product according to claim 13 in which the control information reflects the occurrence of exceptions in particular ones of data access exceptions.

15. The program product according to claim 13 in which the instruction stream is processed in at least two reorder buffers, and at least one subcommit process generates information usable for synchronizing the operation of said at least two reorder buffers.

16. The program product according to claim 13 in which different types of instructions are processed in respective different reorder buffers.

17. The program product according to claim 16 wherein said method further comprises the steps of:
processing by a first reorder buffer, instructions accessing registers, and
processing by a second reorder buffer, instructions accessing a data cache or other data storage system.

18. The program product according claim 13 wherein the method further comprises the step of:
stalling said precommitter at a load instruction which gets data forwarded from a store instruction until said data is visible to any processors in use.
